(19) United States
(12) Patent Application Publication
(10) Pub. No.: US 2017/0232473 A1
(43) Pub. Date: Aug. 17, 2017

(54) ULTRASONIC ELECTROSTATIC DEVICE

(71) Applicant: uBeam Inc., Santa Monica, CA (US)

(72) Inventors: Paul Reynolds, Issaquah, WA (US); Andrew Joyce, Venice, CA (US)

(21) Appl. No.: 15/041,763

(22) Filed: Feb. 11, 2016

(51) Int. Cl. B06B 1/02

(52) U.S. Cl. CPC B06B 1/0292

(57) ABSTRACT

Systems and techniques are provided for an ultrasonic electrostatic device. A device may include a substrate comprising an indentation. A first electrode may be located within the indentation. A membrane may be affixed to the substrate and may cover the indentation. The membrane may include a second electrode. The first electrode and the second electrode may be electrically connected to a circuit such that the first electrode and the second electrode form a parallel plate capacitor.

### BACKGROUND

Ultrasonic sound waves may be used in a variety of applications, including acoustic imaging, point-to-point communications, object detection, and wireless power transfer. Capacitive micromachined ultrasonic transducers (CMUTs) may be used to generate ultrasonic sound waves. CMUTs may be manufactured using semiconductor manufacturing techniques, and may require high levels of bias voltage to operate.

### BRIEF SUMMARY

A device may include a substrate comprising an indentation. A first electrode may be located within the indentation. A membrane may be affixed to the substrate and may cover the indentation. The membrane may include a second electrode. The first electrode and the second electrode may be electrically connected to a circuit such that the first electrode and the second electrode form a parallel plate capacitor.

A device may include a substrate including indentations, each of the indentions having a first electrode located within the indentation. The device may include membranes. Each of the membranes may be affixed to the substrate and may cover one or more of the indentations. Each of the membranes may include a second electrode.

Systems and techniques disclosed herein may allow for an ultrasonic electrostatic device. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example ultrasonic electrostatic device element according to an implementation of the disclosed subject matter.

FIG. 2 shows an example ultrasonic electrostatic device element according to an implementation of the disclosed subject matter.

FIG. 3 shows an example ultrasonic electrostatic device element e according to an implementation of the disclosed subject matter.

FIG. 4 shows an example ultrasonic electrostatic device element according to an implementation of the disclosed subject matter.

FIG. 5 shows an example ultrasonic electrostatic device element according to an implementation of the disclosed subject matter.

FIG. 6 shows an example ultrasonic electrostatic device according to an implementation of the disclosed subject matter.

FIG. 7 shows an example ultrasonic electrostatic device according to an implementation of the disclosed subject matter.

FIG. 8 shows a computer according to an embodiment of the disclosed subject matter.

FIG. 9 shows a network configuration according to an embodiment of the disclosed subject matter.

### DETAILED DESCRIPTION

According to embodiments disclosed herein, an ultrasonic electrostatic device may allow for the generation of ultrasonic sound waves. The ultrasonic electrostatic device may generate ultrasonic sounds waves using electrostatic attraction between electrodes.

An electrostatic device element may include a solid, or rigid, substructure. The substructure may include an indentation. An electrode may be located at the bottom of the indentation, and may have a lead or trace to connect the electrode to a power supply. A membrane may be placed over the indentation on the top of the substructure, covering the indentation and the electrode. The membrane may be, or may be attached to, another electrode, which may also include a lead or trace to connect the electrode to a power supply. An electrical signal may be supplied to both the electrode in the indentation and the electrode of the membrane so that they take on opposite charges. Electrostatic attraction may draw the electrode of the membrane, and the membrane, towards the electrode in the indentation. The electrical signal to one or both of the electrodes may be varied, changing the strength of electrostatic attraction between the electrodes and causing the membrane to vibrate back and forth as the strength of the electrostatic attraction between the electrodes fluctuates. The electrical signals may be varied so that the membrane vibrates at ultrasonic frequencies, for example above 40 KHz. When subject to ultrasonic waves, the membrane of an electrostatic device element may vibrate, generating an electrical signal in the electrode in the indentation. An ultrasonic electrostatic device may include multiple electrostatic device elements which may be arranged on the same substructure.

The substructure for an electrostatic device may be made from any suitable material or combination of materials. The substructure may be suitably solid or rigid, for example, to support the movement of the membrane. For example, the substructure may be printed circuit board (PCB) or a plastic plate. The substructure may be patterned with a number of indentations. The indentations may be made in any suitable manner. For example, holes may drilled into a substructure, an array or grid of spheres or structures may be mechanically or thermally pressed into a deformable substructure, may be chemically etched into the substructure, or may be created using laser micromachining or 3D printing techniques. The indentations in the substructure may be spaced regularly or irregularly, may be placed in any suitable pattern, or may be placed randomly. The indentations may be of any suitable depth and diameter, and of any suitable shape, including, for example, circular, square, hexagonal, octagonal, and so on. The same substructure may include indentations of different shapes and sizes, and created using different processes.

The number of indentations may correspond to the number of electrostatic device elements that the electrostatic device has. For example, each electrostatic device element may have its own indentation in the substructure. In some implementations, more than one electrostatic device element may share a single indentation. In some implementations, a single electrostatic device element may use more than one indentation.

An electrode pattern may be added to the substructure. The electrode pattern may be added to the substructure in any suitable manner, such as, for example, screen printing the electrode pattern onto the substructure. A PCB used as a substructure may have the electrode pattern added to the PCB layers using any suitable technique for creating circuitry in a PCB, including any subtractive, additive, and semi-additive techniques. The electrode pattern may provide an electrical connection to each electrostatic device element of the electrostatic device, so that an electrical signal may be supplied to, or received from, the electrostatic device elements. Each electrostatic device element may receive or send its own electrical signal in parallel, or electrostatic device elements may be grouped into groups of any suitable size which may share an electrical signal. The electrode pattern added to the substructure may include an electrode within, or at the bottom, of the indentations in the substructure. The electrodes may be, for example, circular electrodes at the bottom of the indentations. Any suitable type of electrode may be used in the indentations, and the electrodes may be uniform, or different indentations may have different electrodes. An insulating or dielectric material may be used to partially or wholly cover an electrode in an indentations, or the electrode may be left exposed.

Membranes may be placed over the indentations in the substructure of the electrostatic device. Each indentation may be covered by its own membrane, or a membrane may cover a number of indentations. A membrane may be made from any suitable material or combination of materials which may support vibration at speeds necessary for ultrasonic vibration of the membrane and may efficiently transfer vibration to a medium such as the air. A membrane may be appropriately flexible and rigid. A membrane may be any suitable shape. For example, a membrane may be the same shape as the indentation which it covers, or may be a different shape. A membrane may be secured to the substructure in any suitable manner, including, for example, through the use of epoxies or other adhesives, or through other forms of mechanical attachment. A membrane may be secured to the substructure with any suitable level of tension. For example, a membrane may be secured over an indentation with a level of tension that prevents the membrane from moving noticeably due to gravity, for example, falling into the indentation or away from the indentation depending on the orientation of the electrostatic device.

A membrane may have electrical properties, such as, for example, conductivity. The membrane material itself may be conductive, or an electrode may be added to the membrane material. For example, membranes may be made from electroded Mylar or flexible PCB with metal on one or both sides of the PCB substrate. The membrane's electrode may be one of the two electrodes of an electrostatic device element, along with the electrode in the indentation covered by the membrane. In some implementations, a single continuous electrode may be used in place of separate electrodes at each element, for example a single electrode on the membrane, or a single electrode on the substrate. A membrane's electrode may include a pattern for external electrical connection, allowing an electrical signal to be supplied to the membrane's electrode. The electrode pattern may affect the bias voltage applied to the membrane electrode, and the frequency and amplitude of the output of the membrane when the membrane vibrates. The electrode pattern may also affect the mechanical properties of the membrane based on the thickness, materials, and structure of the electrode pattern, for example, changing the mass and thickness of the membrane and the rigidity and flexibility of the whole membrane and of different areas of the membrane. The affect the electrode pattern has on the mechanical properties of the membrane may change the various operational characteristics of the membrane, including, for example, the frequency, displacement shape, amplitude, and effective acoustic impedance of the membrane when the membrane vibrates. In some implementations, an additional layer or layers, such as metals or plastics, may be laminated onto the membrane for mechanical purposes, for example, to adjust one or more mechanical properties of the membrane. This additional layer may be structured or patterned in a manner to alter the effective stiffness or elastic response of the membrane.

A DC voltage may be supplied to an electrostatic device element. The DC voltage may be supplied to a circuit formed by an electrode in an indentation of the electrostatic device element and an electrode of a membrane covering the indentation. The DC voltage may be a bias voltage for the electrostatic device element, and may cause the electrode in the indentation to be charged oppositely from the electrode of the membrane, as the electrodes may act as a capacitor in the circuit. This may result in a steady state bias of the membrane towards the indentation due to electrostatic attraction between the oppositely charged electrodes. Each electrode may be charged based on the terminal of a DC power supply which it is closer to in the circuit. For example, traces may connect the electrode in the indentation to the negative terminal of the DC power supply, resulting in the electrode in the indentation becoming negatively charged, while traces may connect the electrode of the membrane to the positive terminal, resulting in the electrode of the membrane becoming positively charged. The properties of the DC voltage, such as, for example, the voltage and current levels of the DC voltage, may affect the response frequency and amplitude of the electrostatic device element. The DC voltages supplied to different electrostatic device elements of an electrostatic device may be different, for example, to provide frequency variation or to compensate for manufacturing variations among the electrostatic device elements.

A driving electrical signal, such as a pulse, continuous wave (CW), or AC electrical signal may be supplied to an electrostatic device element in addition to the DC voltage. The driving electrical signal may be supplied to the circuit formed by the electrode in the indentation of the electrostatic device element and the electrode of the membrane. The driving electrical signal may cause a change in the charge balance between the two electrodes. This may cause the membrane to move towards the electrode in the indentation as the charge imbalance increases, due to increased electrostatic attraction, and away from the electrode in the indentation as the charge imbalance decreases, due to decreased electrostatic attraction and the mechanical restorative force of the tension on the membrane. Variation in the driving electrical signal, for example, due to the phases of an AC or CW signal or the pattern of a pulse signal, may be used to cause the membrane of the electrostatic device element to vibrate as the membrane of the electrode is alternately attracted and repulsed by the electrode in the indentation.

The frequency of the driving electrical signal may control the frequency of the membrane's vibrations and the sound waves output from the electrostatic device element, which may be ultrasonic, for example, greater than 40 KHz. The amplitude of the driving electrical signal may control the amplitude of the membrane's vibrations and the sound waves output from the electrostatic device element, for example, with higher voltages resulting in larger amplitudes. The frequency and amplitude of the vibrations of the membrane may be partially based on the DC voltage used to maintain the steady state bias of the membrane. For example, the steady state bias of the membrane may set a maximum amplitude of the movement of the membrane in the direction of the bias, and may set the amplitude of the membrane's vibrations and the output sound waves. This may affect the maximum frequency of the membrane's vibrations, as the membrane may have some maximum speed at which it may move from peak to trough and vice versa during vibration. Greater amplitudes may result in lower maximum frequencies, as the membrane may need to move a greater distance when vibrating. The ultrasonic sound waves output from an electrostatic device element may be used for the wireless transmission of power, or may be used for other purposes, such as, for example, communications, imaging, and object detection.

Each electrostatic device element of an electrostatic device may be controlled individually by the driving electrical signal. For example, each electrostatic device element may receive its own driving signal. This may allow for variation in the frequency and amplitude of ultrasonic sound waves output from various electrostatic device element on the same electrostatic device, which may be used to create phase variations in the ultrasonic sound waves output from the electrostatic device elements. Phase variation may be used, for example, to steer ultrasonic sound waves output from the electrostatic device based on the ultrasonic sound waves output from the individual electrostatic device elements, for example, by controlling constructive and destructive interference.

Electrostatic device elements may also operate to receive ultrasonic sounds waves, and to convert the received ultrasonic sounds waves into an electrical signal. The electrical signal may be used, for example, to power an electronic device or charge a battery, capacitor, or other electrical storage. The electrical signal may also receive wireless communications transmitted via ultrasonic sound waves, or may be based on reflected ultrasonic sound waves used for imaging and object detection. The electrode of a membrane may be charged oppositely from the electrode in an indentation covered by the membrane due to DC voltage supplied to an electrostatic device element. The membrane may be steady state biased towards the electrode in the indentation. Ultrasonic sound waves received at the electrostatic device element may cause vibration of the membrane, with the membrane being pushed further towards the electrode in the indentation by high pressure portions of the ultrasonic sound wave, and returning towards its stead state bias distance from the indentation during the low pressure portions of the ultrasonic sound wave due to the tension across the membrane. As the membrane vibrates, the distance between the electrode of the membrane and the membrane in the indentation may change, changing the potential of the capacitor formed by the two electrodes and resulting in the generation of AC voltage.

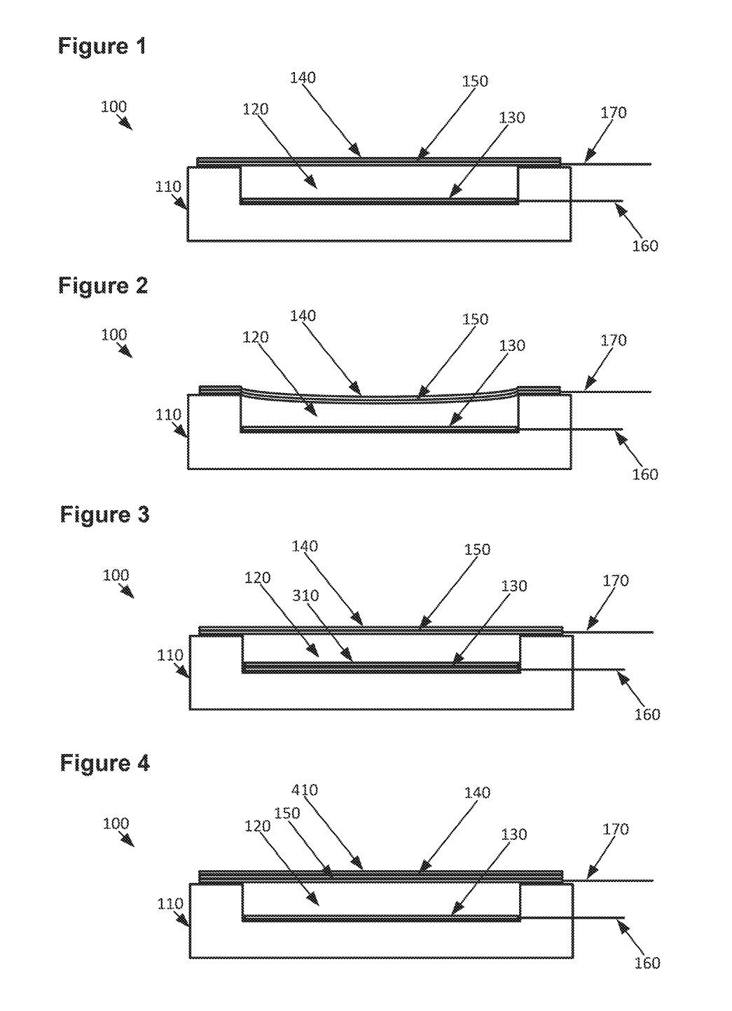

FIG. 1 shows an example ultrasonic electrostatic device element according to an implementation of the disclosed subject matter. An electrostatic device element 100 may include a substrate 110. The substrate may be, for example, PCB or a plastic plate. The substrate 110 may include an indentation 120, which may be of any suitable shape, depth, and diameter. An electrode pattern may be added to the substrate 110, and may include an electrode 130 at the bottom of the indentation 120. The electrode pattern may also include the trace 160, which may be used to connect the electrode 130 to an electrical circuit that may include, for example, AC and DC power supplies, electrical storage, signal processors and signal generators for communication and imaging, and other suitable circuitry which the electrostatic device element 100 may receive electrical signals from or send electrical signals to. The trace 160 may be routed in any suitable manner. For example, the trace 160 may be routed out of the indentation 120 using vias, may be part of a conductive layer of PCB on which the electrode 130, and electrode pattern including the trace 160, may be etched before being covered with an insulating layer into which the indentation 120 may be, or may have been, made, for example, as a drill hole, or the trace 160 may be routed out over a wall of the indentation 120.

A membrane 140 may be stretched over the indentation 120. The membrane 140 may be made of any suitable material, of any suitable flexibility and rigidity for vibration at ultrasonic frequencies. The membrane 140 may include an electrode 150. For example, the membrane 140 and electrode 150 may be electroded Mylar, or may be a flexible PCB, with a conductive layer and substrate layer. The membrane 140, including the electrode 150, may be attached to the substrate 110 over the indentation 120 in any suitable manner, for example, through use of epoxies or other adhesives, or through other forms of mechanical attachment. The membrane 140 may be attached to the substrate 110 with any suitable level of tension, so that, for example, the membrane 140 may not move, or may only move a small amount, relative to the indentation 120 due to gravity. A trace 170 may be a part of an electrode pattern on the substrate 110, and may connect the electrode 150 to an electrical circuit that may include, for example, AC and DC power supplies, electrical storage, signal processors and signal generators for communication and imaging, and other suitable circuitry which the electrostatic device element 100 may receive electrical signals from or send electrical signals to. The trace 160 and the trace 170 may, for example, be part of an electrical circuit in which the electrode 130 and the electrode 150 act as a parallel plate capacitor.

FIG. 2 shows an example electrostatic device element according to an implementation of the disclosed subject matter. A DC voltage may be supplied to the electrode 130 and the electrode 150, for example, through the traces 160 and 170. For example, the trace 160 may connect to the negative terminal of a DC power supply, while the trace 170 may connect to the positive terminal of a DC power supply. The DC voltage may result in a negative charging of the electrode 130 and a positive charging of the electrode 150. Electrostatic attraction may draw the electrode 150, and attached membrane 140, towards the electrode 130 in the indentation 120. As the voltage between the electrode 130 and the electrode 150 reaches equilibrium with the level of the supplied DC voltage, the membrane 140 may maintain a steady state bias, flexed towards the electrode 130.

The steady state bias position of the membrane 140 may affect the amplitudes and frequencies at which the electrostatic device element 100 may operate. For example, the maximum amplitude of the vibration of the membrane 140 may be half the distance between the steady state bias positon of the membrane 140 and the top of the indentation 120. The maximum frequency may be determined by the maximum speed at which the membrane 140 may move from the steady state bias position to the top of the indentation 120.

During transmitting operations, an AC voltage may be supplied to the electrostatic device element 100 in addition to the DC voltage. The AC voltage may be supplied to the electrodes 130 and 150 through the traces 160 and 170. When the electrode 130 is negatively charged due to the DC voltage, the AC voltage may cause the negative charge level of the electrode 130 to decrease as the positive charge of the electrode 150 decreases and the negative charge level of the electrode 130 to increase as the positive charge level of the electrode 150 increases. The variation the charge imbalance between the electrodes 130 and 150 may cause the membrane 140 to vibrate as the electrostatic forces acting of the electrode 150 change. The membrane 140 may vibrate based on the frequency of the AC voltage, which may 50 KHz or greater, resulting in the generation of ultrasonic sound waves by the vibrations of the membrane 140. During receive operations, ultrasonic sound waves may arrive at the membrane 140, causing it to vibrate. The membrane 140, and attached electrode 150, may alternately move towards the electrode 130 during exposure to high pressure portions of the ultrasonic sound waves due to the force of the sound waves, and away from the electrode 130 during low pressure portions of the ultrasonic sound waves due to the mechanical restorative force of the tension on the membrane 140. The changing of the distance between electrodes 130 and 150, which may have been charged by the DC voltage, may result in the generation of an AC voltage with a frequency and amplitude based on the frequency and amplitude of the received ultrasonic sound waves.

FIG. 3 shows an example ultrasonic electrostatic device element according to an implementation of the disclosed subject matter. In some implementations, the electrode 130 may be covered, wholly or partially, by an insulator 310. The insulator 310 may be, for example, a thin dielectric material applied over the electrode 130 to physical and electrical contact between the electrode 130 and the electrode 150. The insulator 310 may also be used to change the dielectric properties of the gap between the electrode 130 and the electrode 150, which may alter the electrostatic attraction between the electrodes 130 and 150 at different voltage levels.

FIG. 4 shows an example ultrasonic electrostatic device element according to an implementation of the disclosed subject matter. In some implementations, a second layer 410 may be added to the membrane 140. The second layer 410 may be in addition to the electrode 150, and may be made of any suitable material, such as a metal, for adjusting various properties of the membrane 140. The second layer 410 may be added to the membrane 140, for example, to change the mass, stiffness, thickness, flexibility, and rigidity of the entirety of, or various areas of, the membrane 140. The second layer 410 may be located on the side of the membrane 140 opposite the side where the electrode 150 is located.

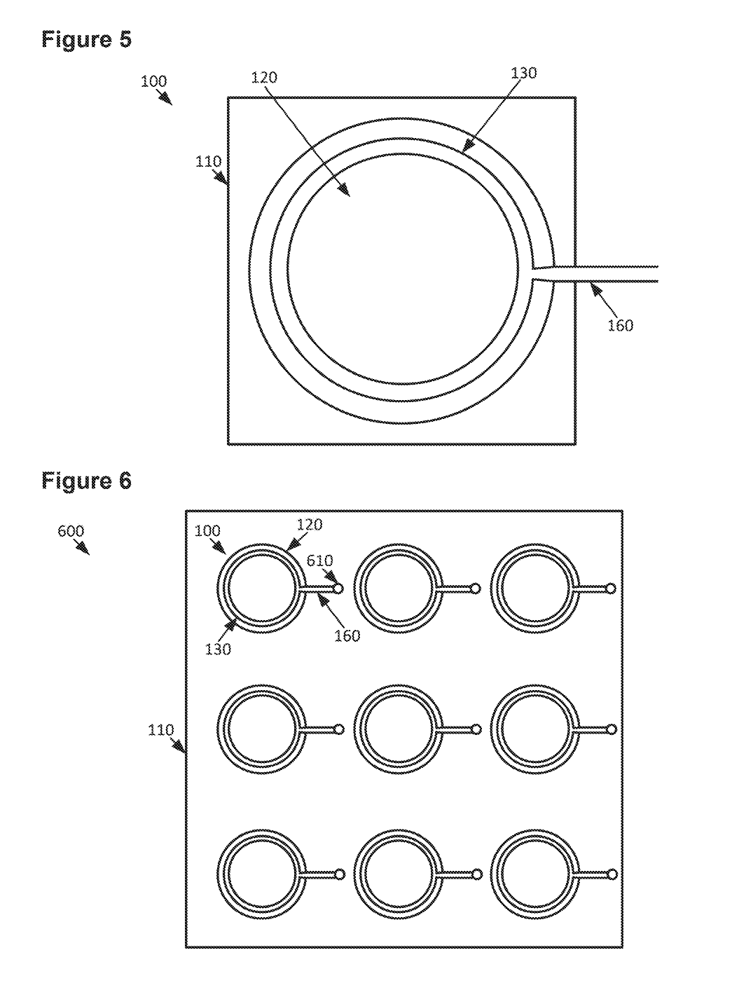

FIG. 5 shows an example ultrasonic electrostatic device element according to an implementation of the disclosed subject matter. In some implementations, the indentation 120 may be circular. The electrode 130 may be a circular electrode at the bottom of the indentation 120. The trace 160 may enter the indentation 120 and connect to the electrode 130 in any suitable manner. For example, the trace 160 may run along the surface of the substrate 110 above the indentation 120, drop down the wall of the indentation 120, and connect to the electrode 130 at the bottom of the indentation 120.

FIG. 6 shows an example ultrasonic electrostatic device according to an implementation of the disclosed subject matter. An ultrasonic electrostatic device 600 may include a number of ultrasonic electrostatic device elements 100. For example, several indentations 120 may be made in the substrate 110. The indentations 120 may be made in a regular pattern on the substrate 110, for example, through drilling, etching, mechanical or thermal pressing, laser micromachining, or 3D printing. Each indentation may include an electrode 130, which may be created in any suitable manner. For example, the electrodes 130 may be part of a conductive layer of a PCB into which the electrodes 130 and traces 160, and other parts of the electrode pattern, may be etched before a substrate layer of the PCB is applied. The substrate layer of the PCB may already have the indentations 120, or they may be created by removing portions of the substrate layer that are over the electrodes 130. Other additive, semi-additive, and subtractive techniques may be used to add the electrodes 130 to a PCB used as the substrate 110. The electrodes 130 may also be added through, for example, through screen-printing of the electrodes 130 and traces 160 onto the substrate 110. In some implementations, the electrode pattern may include vias 610, which may be used to electrically connect the traces 160 to a circuitry on a different layer, or on the back side, of the substrate 110.

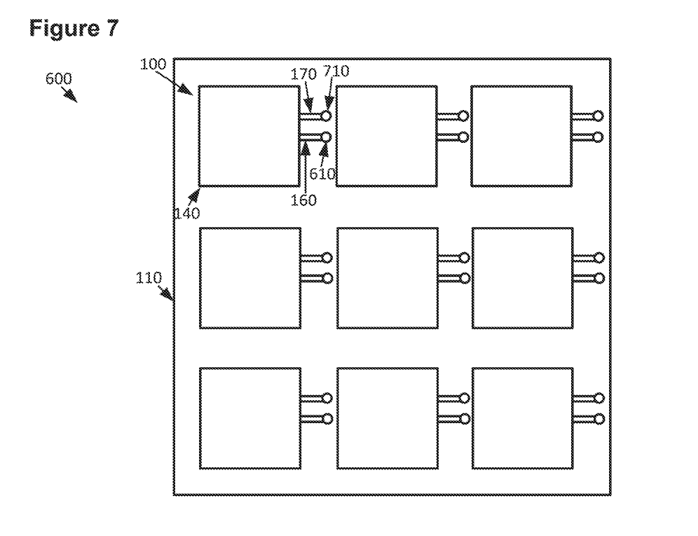

FIG. 7 shows an example ultrasonic electrostatic device according to an implementation of the disclosed subject matter. Membranes 140 may be added to electrostatic device elements 100 of the ultrasonic electrostatic device 600. Each of the indentations 120 may be covered by a membrane 140. The membranes 140 may be any suitable size and shape, and made of any suitable material for vibration at ultrasonic frequencies. The membranes 140 may include electrodes 150, for example, on the underside of the membrane 140. The membranes 140 may be attached to the substrate 110 in any suitable manner, for example, with epoxies or other adhesives, or through other forms of mechanical attachment, and may be tensioned with any suitable amount of force. For example, the membranes 140 may be tensioned such that they do not easily move under the force of gravity while still being flexible enough to flex into the indentation 120. Traces 170 may connect the electrodes 150 to the electrode pattern of the substrate 110. In some implementations, the electrode pattern may include vias 710, which may be used to electrically connect the traces 170 to circuitry on a different layer, or on the back side, of the substrate 110.

Each electrostatic device element 110 of the ultrasonic electrostatic device 600 may be individually controllable. For example, the traces 160 and 170 of each electrostatic device element 100 may be connected in parallel to DC power supply, AC power supply, electrical storage, signal processing electronics, and signal generation electronics. This may allow the DC voltage supplied to each of the electrostatic device elements 100 to vary between different electrostatic device elements 100, for example, to compensate for varying properties between electrostatic device elements 100 due to manufacturing tolerances. The AC voltage supplied to each electrostatic device element 100 may also vary, for example, allowing for phase, frequency, and amplitude differences in the ultrasonic sound waves generated by the electrostatic device elements 100. This may allow for control of the ultrasonic sound wave output of the ultrasonic electrostatic transmitter 600, for example, using constructive and destructive interference to steer and focus an ultrasonic sound wave beam, generating multiple ultrasonic sound wave beams targeted in different directions using different groups of electrostatic device elements 100, and controlling the generation of ultrasonic sound waves used for communication, imaging, object detection, or other purposes.

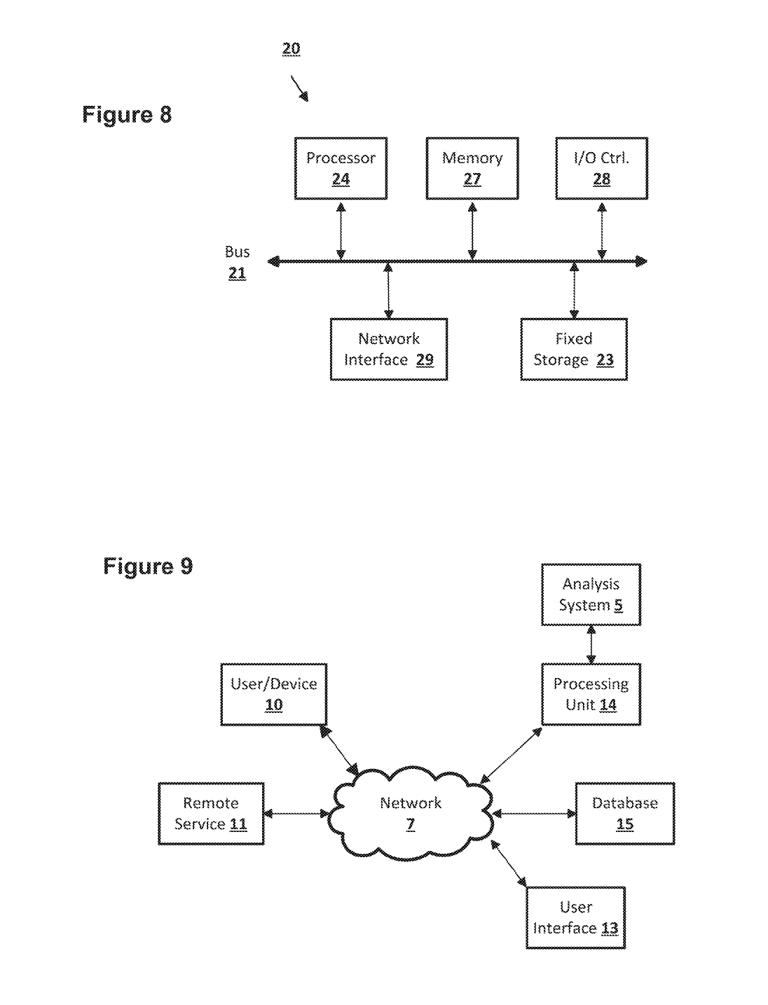

Embodiments of the presently disclosed subject matter may be implemented in and used with a variety of component and network architectures. FIG. 8 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 9.

Many other devices or components (not shown) may be connected in a similar manner, such as document scanners, digital cameras, auxiliary, supplemental, or backup systems, or the like. Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 9 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A device comprising:
a substrate comprising an indentation;
a first electrode disposed within the indentation; and
a membrane affixed to the substrate and covering the indentation, the membrane comprising a second electrode, the first electrode and the second electrode electrically connected to at least one circuit such that the first electrode and the second electrode form a parallel plate capacitor.

2. The device of claim 1, wherein the membrane comprises a flexible material.

3. The device of claim 1, wherein the membrane comprises electroded Mylar or a flexible printed circuit board.

4. The device of claim 1, wherein the membrane is affixed to the substrate with one or more of an epoxy, and adhesive, and a mechanical fastener.

5. The device of claim 1, wherein the membrane is affixed to the substrate such that a tension in the membrane prevents the membrane from moving more than a threshold amount due to the force of gravity.

6. The device of claim 1, wherein a DC voltage supplied to the circuit comprising the first electrode and the second electrode induces opposite charges in the first electrode and the second electrode.

7. The device of claim 1, wherein the membrane is affixed to the substrate such that a tension in the membrane allows the membrane to flex into the indentation when an electrostatic force that attracts the first electrode and the second electrode to each other is increased.

8. The device of claim 1, wherein the membrane is affixed to the substrate such that a tension in the membrane allows the membrane to move towards an original position of the membrane due to the mechanical restorative force of the tension when an electrostatic force that attracts the first electrode and second electrode to each other is decreased.

9. The device of claim 1, wherein the membrane comprises a material adapted to vibrate at ultrasonic frequencies.

10. A device comprising:
a substrate comprising a plurality of indentations, each of the plurality of indentions having a first electrode disposed within the indentation; and
a plurality of membranes, each of the plurality of membranes affixed to the substrate and covering one or more of the plurality of indentations, each of the plurality of membranes comprising a second electrode.

11. The device of claim 10, wherein each of the first electrodes disposed within the plurality of indentations is connected with a separate on one of the second electrodes in an electrical circuit to form a parallel plate capacitor.

12. The device of claim 11, wherein each electrical circuit is controllable separately from the other electrical circuits.

13. The device of claim 10, wherein each of the plurality of membranes covers a single one of the plurality of indentations.

14. The device of claim 10, wherein each of the plurality of indentations is circular.

15. The device of claim 10, wherein each of the plurality of membranes is affixed to the substrate such that a tension in the membrane allows the membrane to flex into the indentation when an electrostatic force that attracts the first electrode and the second electrode to each other is increased.

16. The device of claim 11, wherein each electrical circuit is supplied with a DC voltage.

17. The device of claim 16, wherein the DC voltage supplied to each electrical circuit varies.

18. A method comprising:
supplying a DC voltage to a circuit comprising a first electrode and a second electrode, wherein there is a gap between the first electrode and the second electrode; and
supplying an AC voltage to the circuit in addition to the supplied DC voltage, wherein the AC voltage alternates at a frequency at or above a frequency of ultrasonic sound.

19. The method of claim 18, wherein the DC voltage biases a membrane comprising the second electrode toward an indentation comprising the first electrode.

20. The method of claim 19, wherein the AC voltage causes a variance in electrostatic attraction between the first electrode and the second electrode.

21. The method of claim 20, wherein the variance in electrostatic attraction causes the membrane to vibrate at ultrasonic frequencies based on the frequency of the AC voltage.
